(19) United States
(12) Patent Application Publication
(10) Pub. No.: US 2002/0000955 A1
(43) Pub. Date: Jan. 3, 2002

(54) Display panel having sustain electrodes and sustain circuit

(76) Inventors: Sander Derksen, Eindhoven (NL); Alphonsus Maria Van Amesfoort, Eindhoven (NL); Fransiscus Jacobus Vossen, Eindhoven (NL)

Correspondence Address: Corporate Patent Counsel, Philips Electronics North America Corporation, 580 White Plains Road, Tarrytown, NY, 10591, US

(21) Appl. No.: 09/866,820

(22) Filed: May 29, 2001

(30) Foreign Application Priority Data
May 30, 2000 (EP) 00201907.3

(51) Int. Cl. G09G 3/28

(52) U.S. Cl. 345/60

(57) ABSTRACT

A display device comprises groups of scan electrodes (X1, X2) and groups of sustain electrodes (Y1-Y2) forming groups of electrode pairs (X1-Y1, X1-Y2, X2-Y1, X2-Y2). The sustain discharge for at least one of these groups occur at a different time than for at least one other group. The currents during sustain discharge are then distributed in time, reducing the peak heights and reducing losses and stray electromagnetic radiation.

### DESCRIPTION OF PRIOR ART

The invention relates to a flat panel display apparatus comprising plasma discharge cells having sustain electrodes and scan electrodes and a drive circuit. The invention also relates to a method of driving a flat panel display having sustain electrodes and scan electrodes and a drive circuit.

The invention applies particularly to AC plasma display panels (PDPs) used for personal computers, television sets, etc.

In a PDP, each row of the matrix is defined by two electrodes: a scan electrode and a sustain electrode. A cell is defined by one row (two electrodes) and a column electrode.

To show a picture on such a display, a sequence of three driving modes is applied for each sub-frame:

An erase mode, in which old data in the cells is ‘erased’, so the next (sub)frame can be loaded.

A scanning mode, in which the data of the (sub)frame to be shown is written into the cells.

A sustain mode, in which light (and thus the picture) is generated. All cells are sustained at the same time.

It has been found that very high peak currents occur during the sustain discharge. Said peak currents increase the costs of electronics, are a source of resistive losses and a source of EMC (Electromagnetic radiation).

With increasing size, total light output and capacity of the displays, the problems associated with high peak currents will only increase.

### SUMMARY OF THE INVENTION

It is an object of the invention to mitigate one or more of the above-mentioned problems.

To this end, the invention provides a flat panel display apparatus, which is characterized in that the sustain electrodes comprise m groups of sustain electrodes and the scan electrodes comprise n groups of scan electrodes forming groups of electrode pairs, while in operation, the drive circuit applies sustain pulses to the respective groups of electrode pairs which are shifted in phase such that plasma discharge for at least one group of pairs takes place at a different time than for at least one other group of the groups of pairs.

In the prior-art display apparatus, all sustain electrodes are connected and form one common sustain electrode. During the scanning mode, each scan electrode is driven by its own circuitry, but in the sustain mode, all the scan electrodes are in fact connected and form a single scan electrode. The sustain voltage waveforms over all the cells in the display panel is therefore the same, the plasma discharges therefor taking place for all the cells at the same time. This causes very high peak currents. The capacitive charge and discharge currents also take place at the same time. The plasma discharges take place between all electrodes at the same time. Consequently, all peak currents (whether they are plasma discharge currents, capacitive currents, and whether they are to sink or source charge) take place at the same time.

In the display apparatus in accordance with the invention, the peak currents are spread in time because the sustain plasma discharge for at least one of the groups of electrode pairs is shifted in phase in relation to at least one other of the groups of pairs, such that the respective sustain plasma discharges are shifted in time. The peak plasma currents (and the discharge currents) are spread over two (or more) discharge moments and reduced (by a factor of n if there are n discharge moments for an equal number of groups). This may be used to lower dissipation in the sustain circuit or to reduce the number of components (and thereby costs). The dissipation is equal to I²*R*t/T, with I the current, R the resistance (of components in the sustain circuit and t/T the fraction of time the current flows. It can be seen that with n peaks currents having 1/n intensity, the dissipation is decreased by a factor 1/n.

Preferably, the m groups of sustain electrodes and the n groups of scan electrodes form n*m groups of electrode pairs. This allows a more efficient distribution of peak currents across the groups.

Preferably, each group of electrode pairs comprises a substantially equal number of electrode pairs.

The peak currents are then substantially equally distributed across the groups of pairs.

Apart from peak currents occurring within the device as a whole, there are also peak currents occurring within the groups of scan and/or sustain electrodes and their drive circuits. In embodiments of the invention, measures are taken to reduce said currents.

Preferably, n and m>2, while, in operation, the drive circuit applies sustain pulses to the respective groups of sustain electrodes, and groups, of scan electrodes which are shifted with phase in respect to each other. This reduces the plasma discharge current that has to be sinked/sourced through the scan and sustain electrodes per group of electrodes.

Preferably, the phase shifts between pulses on the groups of scan electrodes are substantially an equal amount of 2π/m and/or the phase shifts between pulses on the groups of sustain electrodes are substantially an equal amount of 2π/n.

The discharge moments are then equally distributed with respect to time, further reducing the dissipation and peak currents.

Preferably, the number of groups of scan and sustain electrodes is the same, i.e. n=m, with n preferably being 2 and the phase difference between the sustain pulses applied to the groups of pairs of scan and sustain electrode pairs being substantially 2π/2n. The discharge moments are then equally spaced out in time.

Preferably, there are two groups of sustain electrodes and two groups of scan electrodes (m=n=2), the sustain pulses on the groups of scan electrodes being substantially in counterphase with each other (difference in phase of π), the sustain pulses on the groups of sustain electrodes being substantially in counterphase (difference in phase of π) and the phase difference between sustain pulses between the groups of sustain and scan electrodes being substantially π/2. The same conditions apply for all of the four groups of electrode pairs. This has the distinct advantage that in preferred embodiments a set of two identical drivers can be used, which reduces the costs.

Preferably, the currents in adjacent electrode pairs are in counterphase during discharge. When the discharge is done in counterphase, the currents in adjacent cells and electrode pairs are in opposite directions. By placing rows with an opposed current direction near each other, electromagnetic radiation of these rows cancel each other at some distance of the device. Preferably in operation sustain as well as erase currents are applied substantially in counterphase with each other. Then these currents through the panel and drivers are in opposite phase which strongly reduces the electromagnetic radiation.

Preferably, the display device comprises an energy-recovery circuit and during the energy-recovery period, the scan and sustain electrodes are connected in a Wheatstone bridge configuration having a first, a second, a third and a fourth terminal, the first terminal corresponding to a group of sustain electrodes, the second to a group of scan electrodes, the third to a further group of sustain electrodes and the fourth to a further group of scan electrodes, with a first energy recovery circuit being arranged between the first and third terminals and a second energy recovery circuit being arranged between the second and fourth terminals.

Since the electrodes are arranged in a Wheatstone bridge configuration, i.e. at least substantially balanced, the currents during energy recovery run through an energy recovery system from one group of sustain electrodes to another group of sustain electrodes or from one group of scan electrodes to another group of scan electrodes. No or little current is running from a group of scan electrodes to a group of sustain electrodes or vice versa. In prior-art energy recovery systems, the currents during energy recovery run from the scan electrodes to the sustain electrodes or from each of these groups of electrodes to and from buffer capacitors. This means that a current lead must be provided going from one side of the device to the other, or buffer capacitors must be provided. The currents during energy recovery may be, however, very high (100 Amp). Losses and costs are reduced by having basically two systems, one at each side, without buffer capacitors and with only current leads at either side of the device. It is no longer needed to have an interconnecting low impedance at the back of the panel. Furthermore, each energy recovery system gets less current, which is also an advantage from the point of view of energy losses as well as from the point of view of electromagnetic radiation.

More efficient energy recovery is thereby possible.

These and other objects of the invention are apparent from and will be elucidated with reference to the embodiments described hereinafter.

### SHORT DESCRIPTION OF THE DRAWINGS

In the drawings:

FIG. 1 is a cross-sectional view of a pixel of a PDP device

FIG. 2 schematically illustrates a circuit for driving a PDP of a surface-discharge type in a sub-field mode as known from the prior-art.

FIG. 3 illustrates voltage waveforms between scan electrodes and sustain electrodes of the known PDP.

FIG. 4 further illustrates the layout of pixels in a plasma display panel.

FIG. 5 illustrates schematically a known PDP having 12 rows.

FIG. 6 illustrates the sustain pulses on the scan and sustain electrodes and between them in the known PDP.

FIG. 7 illustrates the arrangement of scan and sustain electrodes in a device in accordance with the invention.

FIG. 8 illustrates the sustain pulses on the scan and sustain electrodes and between them in the device illustrated in FIG. 7.

FIGS. 9 and 10 illustrate simulated current and voltage waveforms of respectively the devices illustrated in FIGS. 5 and 7, respectively.

FIG. 11 shows a preferred embodiment of the invention.

FIG. 12 and 13 illustrate schematically a further preferred embodiment of the device in accordance with the invention having energy recovery circuits.

FIGS. 14A, 14B and 14C illustrate schematically arrangement of electrodes for a section of further embodiments of the device in accordance with the invention.

FIG. 15 illustrates energy recovery systems for the embodiment of FIG. 14C.

FIG. 16 schematically illustrates a display device having two sections each section having a group of electrodes (X1-Y1, X2, Y2) driven with a time difference and having a driver arrangement as schematically illustrated in FIG. 14C.

The Figures are schematic and not drawn on scale. Generally, identical components are denoted by the same reference numerals in the Figures.

### DETAILED DESCRIPTION OF PREFERRED EMBODIMENTS

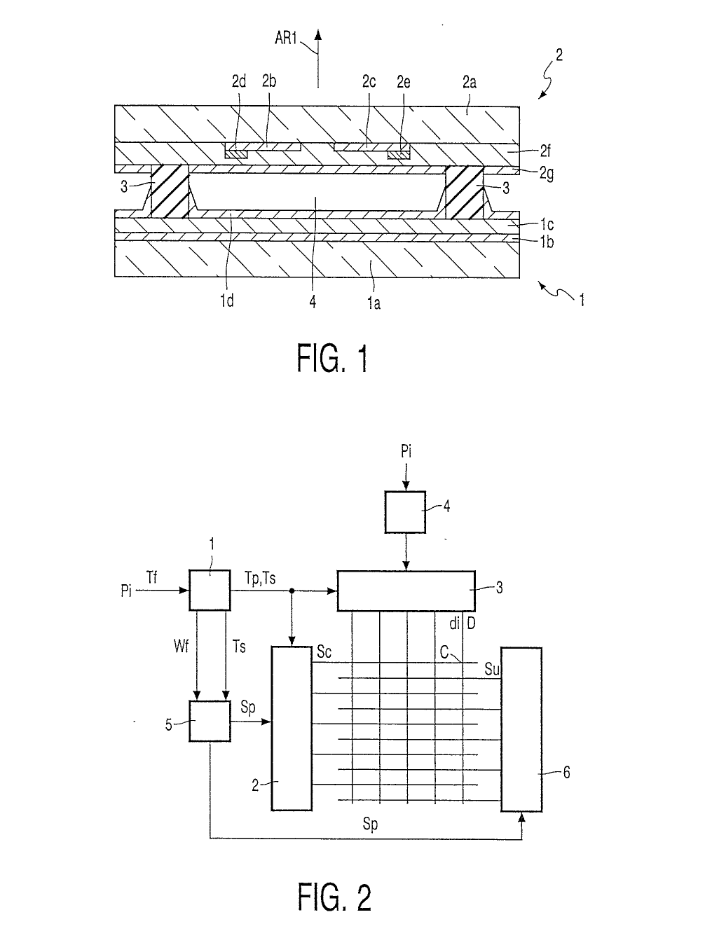

The prior-art pixel shown in FIGS. 1 and 2 produces an image in the following steps.

FIG. 1 illustrates the structure of a pixel. The pixel comprises a back substrate structure 1 and a front structure 2, and a partition wall 3 which spaces the back structure 1 from the front structure 2. Discharge gas 4 such as helium, neon, xenon or a gaseous mixture thereof fills the space between the back structure 1 and the front structure 2. The discharge gas generates ultra-violet light during discharging. The back structure 1 includes a transparent glass plate 1a and a data electrode 1b is formed on the transparent glass plate 1a. The data electrode 1b is covered with a dielectric layer 1c, and a phosphor layer 1d is laminated on the dielectric layer 1c. The ultra-violet light is radiated onto the phosphor layer 1d, and the phosphor layer 1d converts the ultra-violet light into visible light. The visible light is indicated by arrow AR1. The front substrate 2 includes a transparent glass plate 2a, and a scan electrode 2b and a sustain electrode 2c are formed on the transparent glass plate 2a. The scan electrode 2b and the sustain electrode 2c extend perpendicularly to the data electrode 1b. Trace electrodes 2d/2e may be laminated on the scan electrode 2b and the sustain electrode 2c, respectively, and are expected to reduce the resistance against a scanning signal and a sustain signal. These electrodes 2b, 2c, 2d and 2e are covered with a dielectric layer 2f, and the dielectric layer 2f may be covered by a protective layer 2g. The protective layer 2g is for instance formed of magnesium oxide and protects the dielectric layer 2f from the discharge. An initial potential larger than the discharging threshold is applied between a scan electrode 2b and a data electrode 1b. Discharging takes place between them. Positive charge and negative charge are attracted towards the dielectric layers 2f/1c over the scan electrode 2b and the data electrode 1b and are accumulated thereon as wall charges. The wall charges produce potential barriers and gradually decrease the effective potential. Therefore, the discharge is stopped after some time. Thereafter, a sustain pulse is applied between the scan electrodes 2b and the sustain electrodes 2c which pulse is identical in polarity to the wall potential. Therefore, the wall potential is superimposed on the sustain pulse. Because of the superimposition the effective potential exceeds the discharging threshold and a discharge is initiated. Thus, while the sustain pulse is being applied between the scan electrodes 2b and the sustain electrodes 2c, the sustain discharge is initiated and continued. This is the memory function of the device. This process occurs in all pixels at the same time.

When an erase pulse is applied between the scan electrodes 2b and the sustain electrodes 2c, the wall potential is cancelled, and the sustain discharge is stopped. The erase pulse has a wide pulse width and a low amplitude or narrow width.

FIG. 2 schematically illustrates a circuit for driving a PDP of a surface-discharge type in a sub-field mode as known from the prior art. Two glass panels (not shown) are arranged opposite to each other. Data electrodes D are arranged on one of the glass panels. Pairs of scan electrodes Sc and sustain electrodes Su are arranged on the other glass panel. The scan electrodes Sc are aligned with the sustain electrodes Su, and the pairs of scan and sustain electrodes Sc, Su are perpendicular with respect to the data electrodes D. Display elements (for example, plasma cells or pixels C) are formed at the crosspoints of the data electrodes and the pairs of scan and sustain electrodes Sc, Su. A timing generator 1 receives display information Pi to be displayed on the PDP. The timing generator 1 divides a field period Tf of the display information Pi into a predetermined number of consecutive sub-field periods Tsf. A sub-field period Tsf comprises an address period or prime period Tp and a display or sustain period Ts. During an address period Tp, a scan driver 2 supplies pulses to the scan electrodes Sc, and a data driver 3 supplies data di to the data electrodes D to write the data di to the display elements C associated with the selected scan electrode Sc. In this way the display elements C associated with the selected scan electrode Sc are preconditioned. A sustain driver 6 drives the sustain electrodes Su. During an address period Tp, the sustain driver 6 supplies a fixed potential. During a display period Ts, a sustain pulse generator 5 generates sustain pulses Sp which are supplied to the display elements C via the scan driver 2 and the sustain driver 6. The display elements, which are preconditioned during the address period Tp to produce light during the display period Ts, produce an amount of light depending on a number or a frequency of sustain pulses Sp. It is also possible to supply the sustain pulses Sp to either the scan driver 2 or the sustain driver 6. It is also possible to supply the sustain pulses Sp to the data driver 3 or both to the scan driver 2 or to the sustain driver 6 and the data driver 3.

The timing generator 1 further associates a fixed order of weight factors Wf with the sub-field periods Sf in every field period Tf. The sustain generator 5 is coupled to the timing generator to supply a number or a frequency of sustain pulses Sp in conformance with the weight factors Wf such that an amount of light generated by the preconditioned display element C corresponds to the weight factor Wf. A sub-field data generator 4 performs an operation on the display information Pi such that the data di is in conformance with the weight factors Wf.

When regarding a complete panel, the sustain electrodes Sc in the prior art are interconnected for all rows of the PDP panel. The scan electrodes Sc are connected to row ICs and scanned during the addressing or priming phase. The column electrodes Co are operated by column Ics and the plasma cells C are operated in three modes:

1. Erase mode. Before each sub-field is primed, all plasma cells C are erased at the same time. This is done by first driving the plasma cells C into a conducting state and then removing all charge built up in the cells C.

2. Prime mode. Plasma cells C are conditioned such that they will be in an on or off state during the sustain mode. Since a plasma cell C can only be fully on or off, several prime phases are required to write all bits of a luminance value. Plasma cells C are selected on a row-at-a-time basis and the voltage levels on the columns Co will determine the on/off condition of the cells. If a luminance value is represented in 6 bits, then also 6 sub-fields are defined within a field.

3. Sustain mode. An alternating voltage is applied to scan and sustain electrodes Sc, Su of all rows at the same time. The column voltage is mainly at a high voltage potential. The plasma cells or pixels C primed to be in the on state, will light up. The weight of an individual luminance bit will determine the number of light pulses during sustain.

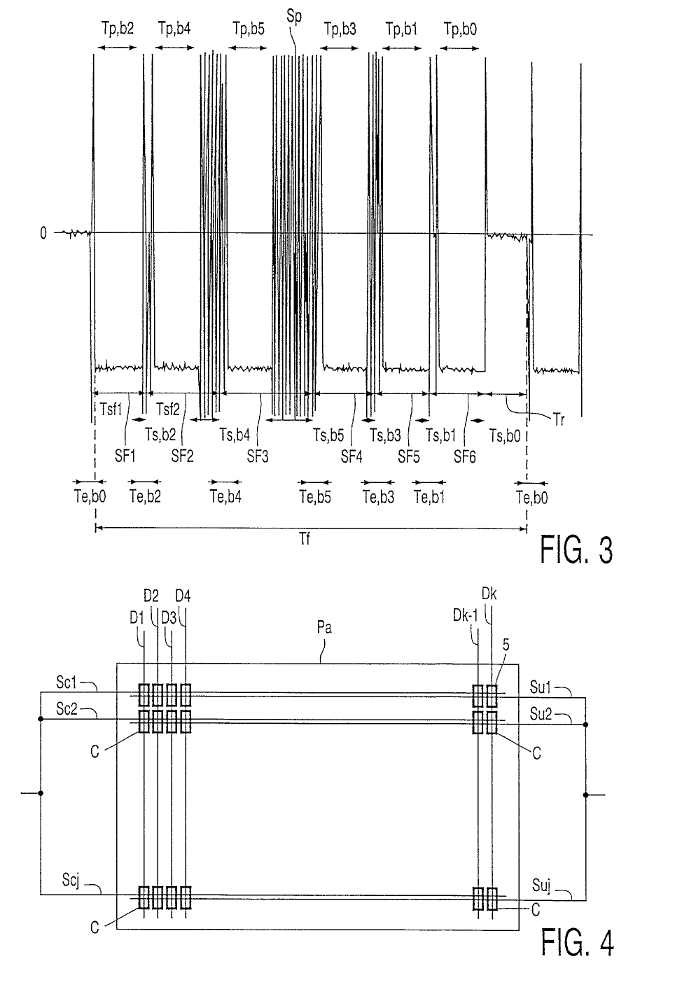

FIG. 3 shows voltage waveforms between scan electrodes Sc and sustain electrodes Su of a known PDP. Since there are three modes, the corresponding time sequence is indicated as Te,bx (erase mode for bit-x sub-field), Tp,bx (prime mode for bit-x subfield) and Ts,bx (sustain mode for bit-x subfield).

FIG. 4 further illustrates the layout of pixels C in a plasma display panel Pa. The pixels are identical in structure to the pixel shown in FIG. 1 and form a display area. The pixels are arranged in j rows and k columns, and a small box stands for each pixel in FIG. 4. Scan electrodes (Sci) and sustain electrodes (Sui) extend in the direction of the rows, and the scan electrodes are paired with the sustain electrodes respectively. The pairs of scanning/sustain electrodes are associated with the rows of pixels respectively Data electrodes (Di) extend in the direction of columns, and are associated with the columns of pixels, respectively.

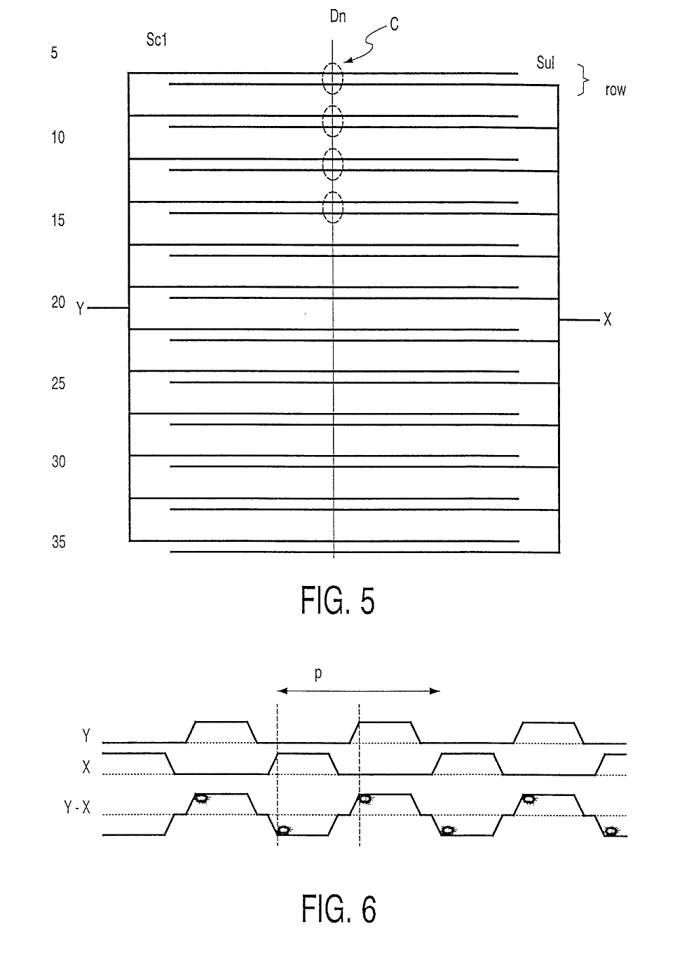

FIG. 5 illustrates schematically a PDP having 12 rows for simplicity. In the prior art display apparatus, all sustain electrodes are connected and form one common sustain electrode (X in FIG. 5). During the scanning mode, each scan electrode is driven by it's own circuitry, but in sustain mode all the scan electrodes are in fact connected and form a single scan electrode (Y in FIG. 5). The sustain voltage waveforms over all the cells in the display panel is therefore the same, the plasma discharge therefor taking place for all the cells at the same time. This causes very high peak currents. The capacitive charge and discharge currents also take place at the same time. FIG. 6 illustrates the pulse on the common scan electrode (Y), the common sustain electrode (X) and the pulse between the electrodes X and Y. The instants at which plasma discharge takes place (Note: two per period) are also indicated by an asterisk. The plasma discharges take place between all electrodes at the same time. Consequently, all peak currents (whether they are plasma discharge currents, capacitive currents, and whether they are to sink or source charge) take place at the same time.

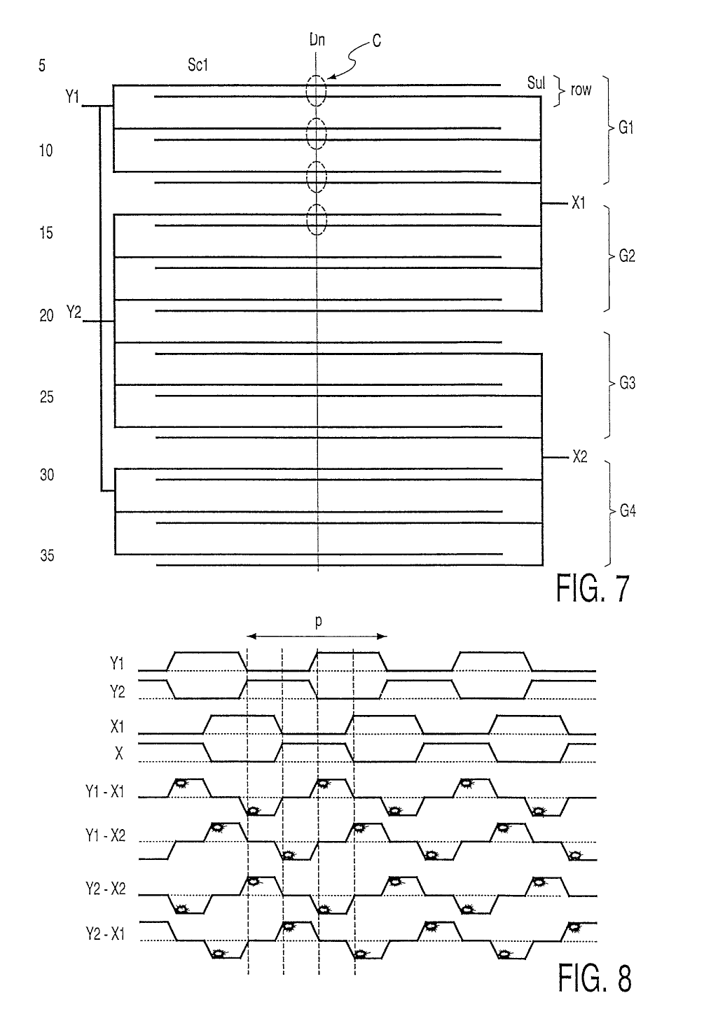

FIGS. 7 and 8 illustrate the display device in accordance with the invention. The sustain electrodes are subdivided in to n groups X1 and X2 (i.e. n=2) and the scan electrodes are subdivided in to m groups Y1 and Y2 (i.e. m=2). Four (n*m) groups of electrode pairs are formed: the first group G1 of Y1 and X1, the second group G2 of Y2 and X1, the third group G3 of Y2 and X2 and the fourth group G4 of Y1 and X2 (see FIG. 7). FIG. 8 illustrates the sustain pulses on the groups of scan electrodes (Y1 ,Y2), the groups of sustain electrodes (X1, X2) and the pulses between the electrodes Xᵢ and Yᵢ. In can be seen that all pulses on the different groups of electrodes are shifted in phase with respect to each other as well as all pulses on the groups of pairs. The sustain pulses on the groups of sustain electrodes (X1-X2) are in counterphase, as they are for the groups of scan electrodes(Y1-Y2). The phase difference between the pulses on the scanning and sustain electrodes is π/2 or a multiple thereof (see, for instance, the groups Y1-X1 and Y1-X2 for which the pulses differ one quarter of a period, i.e. π/2, the groups Y1-X1 and Y2-X2 differ half a period etc.). The instants at which plasma discharge takes place (Note: four per period) are also indicated by an asterisk. The plasma discharges take place between electrodes at the two distinct times. Consequently, the peak currents (whether they are plasma discharge currents, capacitive currents, and whether they are to sink or source charge) are spread over two instances. This can be used to lower dissipation in the sustain circuit or to reduce the number of components (and thereby costs). The dissipation is equal to I²*R*t/T, where I is the current, R is the resistance (of components in the sustain circuit and t/T is the fraction of time the current flows. It can be seen that, with n peak currents having 1/n intensity, the dissipation is decreased by a factor 1/n.

The discharge moments are then equally distributed in time, reducing the dissipation and peak currents. They are also equally distributed across the groups of scan and sustain electrodes.

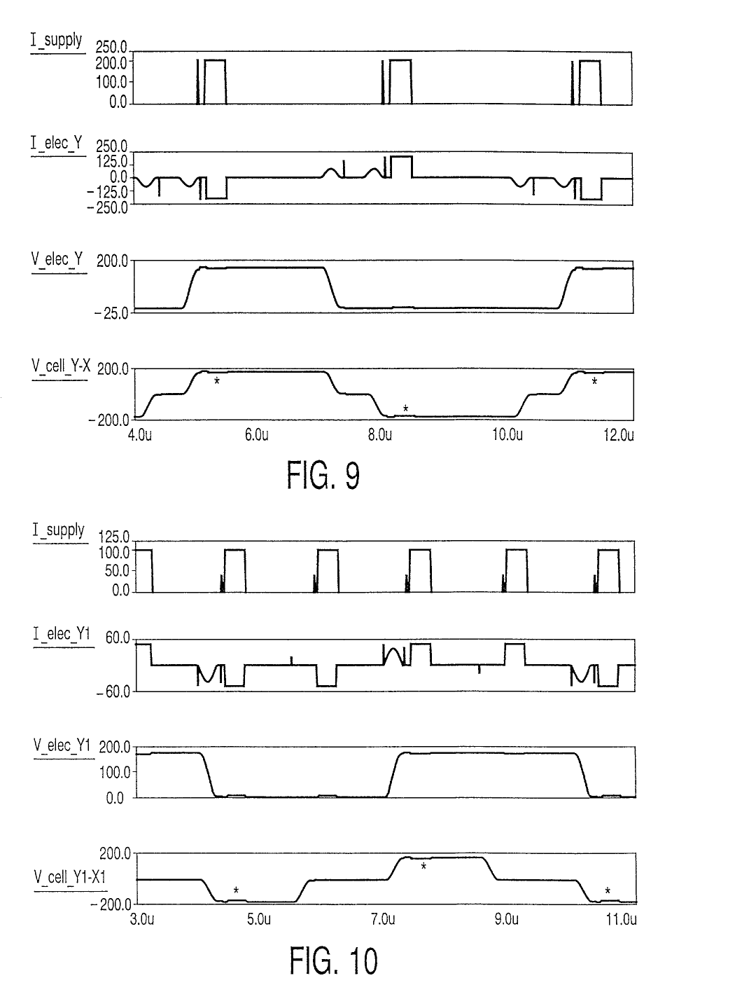

FIG. 9 and FIG. 10 illustrate simulated current and voltage waveforms of the prior art device of FIG. 5 and the device in accordance with the invention of FIG. 7, respectively. In these Figures, the plasma discharge current is modeled by a constant current pulse of 300 ns. The capacitive currents are generated by a series resonance of the driver circuit and the panel capacity. This gives currents with half-sine waveforms. Shortly after this resonance current, a current spike charges the panel capacity to the desired value, as the energy was not completely recovered with the resonant circuit due to series resistance.

The currents through the electrodes Y (I_elec_Y; prior art) and Y1 (I_elec_Y1; new) show that the plasma discharge current through Y1 is only one fourth of the current through Y and flows twice as often. However, electrode Y1 is only loaded with half a panel and Y with the whole panel. Thus when the whole panel is considered, the peak plasma discharge current is halved and flows twice as often. This can also be seen from the current drawn from the power supply (I_supply). The voltage on the electrodes Y is denoted by V_elec_Y and V_elec_Y1. The voltage across a plasma cell C is denoted by V_cell_Y1-X1 and V_cell_Y1-X1.

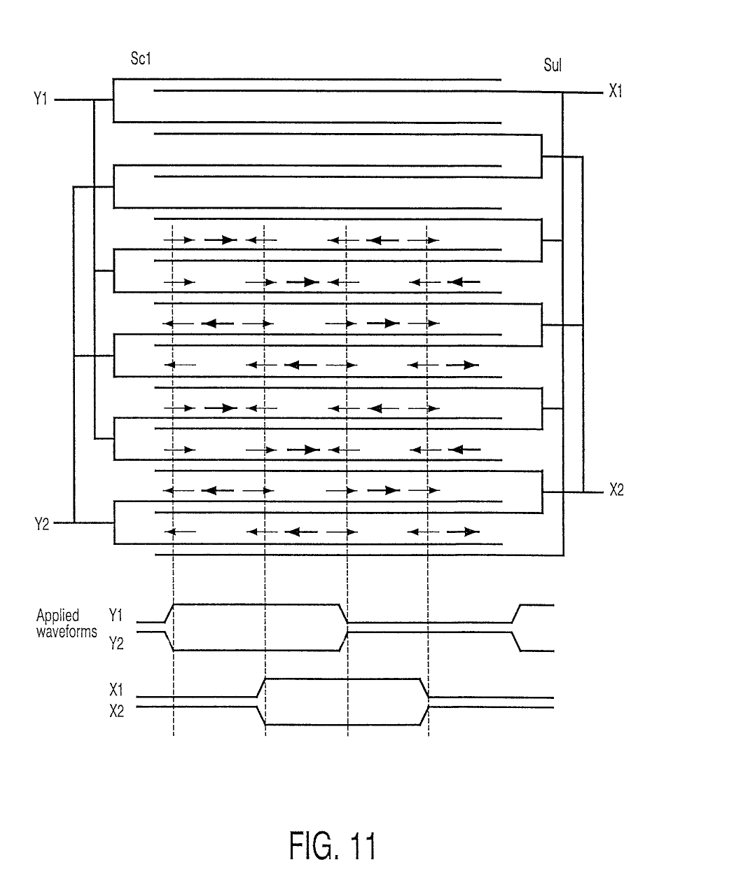

FIG. 11 shows a preferred embodiment of the invention.

In this preferred embodiment, the currents in adjacent pairs of scan and sustain electrodes are in counterphase during discharge. When the discharge is done in counterphase, the currents flow in opposite directions. The small arrows indicate capacitive current, while the large arrows indicate plasma discharge current. Viewed along a vertical line, it can be seen that the current in adjacent rows flows in opposite directions. The electromagnetic fields associated with the currents therefore also flow in opposite directions canceling each other at some distance of and in the device. This reduces interference of such fields with other circuits. Thus, by placing rows with an opposed current direction near each other, electromagnetic radiation's of these rows cancel each other at some distance of and in the device. Voltages on the electrodes Y1, Y2, X1, X2 are shown at the bottom part of FIG. 11. This symmetrical arrangement of 2 by 2 groups allows the use of electronically identical drivers and/or energy recovery systems (preferably integrated in own system) for instance one at the left and one at the right of the display. Also this allows in a simple manner for a device in which in operation sustain as well as erase currents are in counter phase which further reduces the electromagnetic radiation.

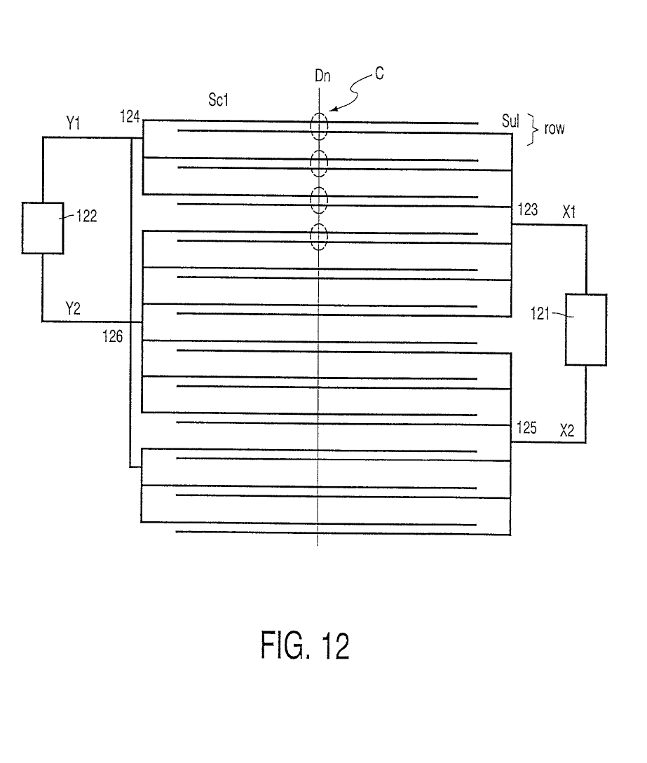

FIG. 12 shows a preferred embodiment of the device in accordance with the invention. Energy recovery circuits 121 and 122 are arranged between the groups of scan electrodes (Y1-Y2) and the groups of sustain electrodes (X1-X2). During energy recovery, the current runs from and to the sustain and scan electrodes through the circuits 121 and 122, respectively. There is no buffer capacitor needed and there is no current running on the outside from one side of the device to the other. The current leads can be made shorter and need to carry less current, reducing losses. The energy recovery circuit needs to handle less energy, which is also an advantage. The groups of scan and sustain electrodes form a Wheatstone bridge configuration with a first terminal 123, a second terminal 124, a third terminal 125 and a fourth terminal 126. The first energy recovery circuit is arranged between the first and third terminals, the second energy recovery circuit is arranged between the second and fourth terminals. It will be clear that the numbering of the terminals as such is arbitrary and only given to be able to name and indicate the terminals.

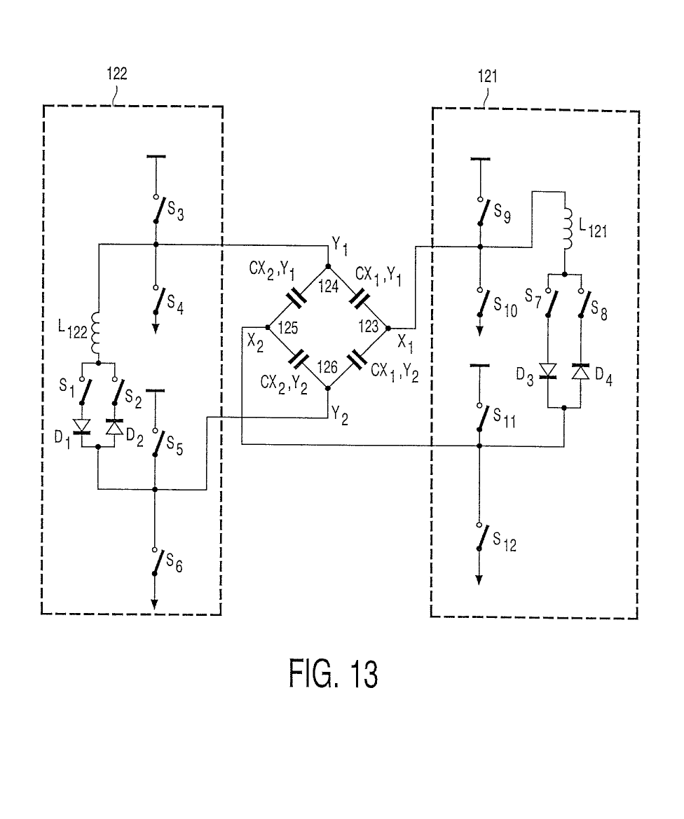

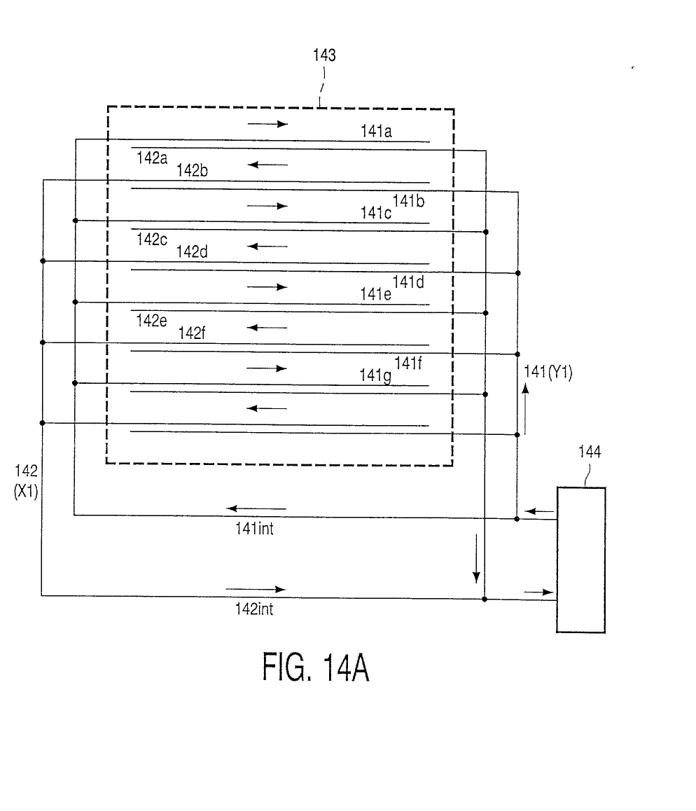

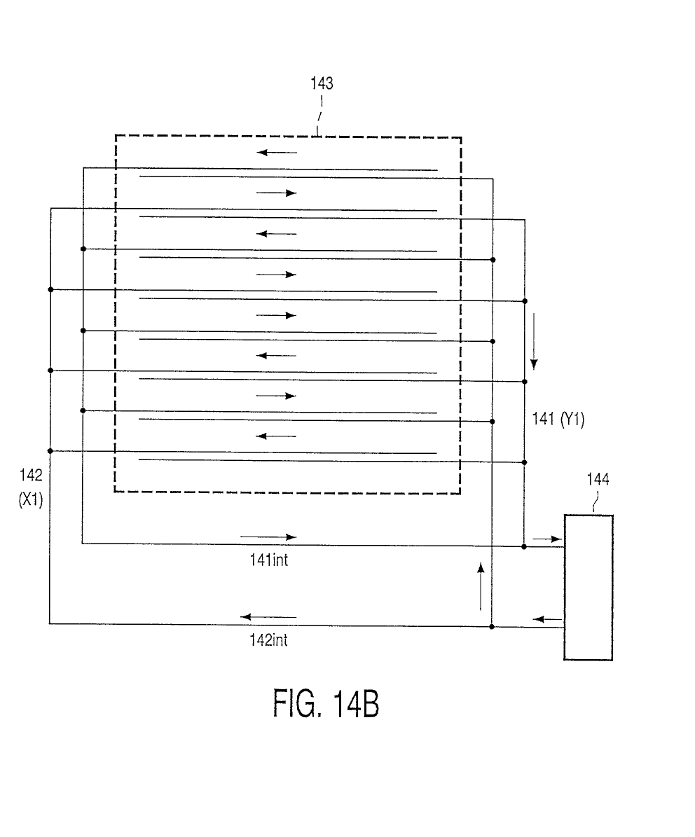

FIG. 13 shows the arrangement of FIG. 12 in more detail. Because the capacitive couplings between the groups of electrodes (indicated by C_{Xi,Yj} in FIG. 13) are substantially the same, a Wheatstone bridge configuration is formed. During energy recovery, a current runs from and between the X1 and X2 electrodes via the energy recovery circuit 121. During such energy recovery, there is no current running between the Y1 and Y2 electrode groups. When current runs via energy recovery circuit 122 to and from electrodes Y1 and Y2, no current is running from X1 to or from X2. FIG. 13 also shows two energy recovery systems which are electronically equivalent. Preferably the energy recovery systems are substantially of the same design, which increases the cost efficiency of manufacturing the energy recovery systems. Preferably the drivers are also substantially of the same design.

In more detail, the energy recovery at, for example, the scanning (Y) side is performed in the following sequence. Assuming, that switch S3 and S6 are closed and switches S4, S6, S1 and S2 are opened at a certain instant, then Y1 is connected to the supply and Y2 to ground. In order to use the energy recovery network to invert the voltages on the Y1 and Y2 simultaneously, switches S3 and S6 are opened first. Then switch S1 is closed and current will flow from the electrode Y1 through coil L122, switch S1 and diode D1 to the Y2 electrode. In the display device itself, current flows from Y2 through the Wheatstone bridge configuration of display capacitance's and the parallel connection of C_{x2,y2} in series with C_{x,2,y1} and C_{x1,y2} in series with C_{x1,y1}, to Y1. If all display capacitance's are equal, the voltage level at electrodes X1 and X2 will not change and no currents will flow to or from electrodes X1 and X2 during this energy recovery phase. Next, if no current is flowing anymore from Y1 to Y2, switch S1 is opened and switches S5 and S4 are closed. Timing for opening switch S1 is not that critical, as diode D1 will block currents from flowing back from electrode Y2 to electrode Y1. Switches S5 and S4 are closed to connect electrode Y1 to ground and electrode Y2 to the supply, thereby charging the display capacitance's to the desired levels and compensating for the inevitable losses during energy recovery due to parasitic resistances in all components. The voltages on the electrodes Y1 and Y2 can be inverted the other way around in the same way, using the appropriate switches in the right sequence. The same energy recovery sequences can be applied at the sustain (X) side.

In known energy recovery systems, energy recovery circuits are arranged between the scanning and sustain electrodes (X and Y) or between each group of electrodes (X and Y) and buffer capacitors. As a consequence, currents leads which must be capable of carrying large currents (which can be as large as 100 amp) run over the length of the device usually along the rear side, or extra components (the buffer capacitors) are needed . In the preferred embodiment, there are current leads at each side of the devices, but not from one side to the other and no buffer capacitors are needed. The length of the leads is substantially reduced, reducing costs, as well as reducing losses within the leads. Furthermore the maximum currents within the energy recovery systems as well as within the leads are reduced, further reducing losses and costs. In the embodiment shown in FIG. 12 and 13 each energy recovery system 121, 122 gets less (compared to known energy recovery systems) current, which is an advantage from the point of view of energy losses as well as from the point of view of electromagnetic radiation even at short distance from the particular energy recovery system. At larger distance a very strong reduction in electromagnetic radiation is obtained due to the cancellation effect of the counterphased currents through the two energy recovery systems.

In the embodiments described above, the device comprises m groups of sustain electrodes and n groups of scan electrodes forming n*m groups of electrode pairs. Although such embodiments are preferred, in other embodiments within the broadest concept of the invention, the device may comprise an equal number of groups of scan and sustain electrodes (i.e. n=m) at each side and each group of sustain electrode pairs is formed only with the scan electrodes of one group of scan electrodes (and vice versa). In this manner, n groups of electrode pairs are formed. The topology of the device is strongly simplified, which in circumstances offers advantages (especially in terms of efficiency of manufacture and reduction of fall-out), yet by spreading in time the discharge moments, the advantages of reduction of peak currents and reduction of radiation are obtained. For instance, when the device comprises four groups of sustain and scan electrodes forming four groups of electrode pairs and four sustain drivers for driving the four groups of electrode pairs driving the four sustain drivers with a time delay with respect to each other so that the plasma discharges take place at a different time, for instance, by introducing a delay period of a quarter of a sine wave period between groups of electrode pairs, a reduction of the peak current for each of the four sustain drivers to 25% of the total peak current is obtained. During energy recovery (independent of the actual energy recovery system used) a time-widened energy recovery pulse with a maximum of approximately 35% of the maximum when the energy recovery pulses are not spaced in time is obtained. As it is widened in time, this broadened pulse comprises much fewer high frequency components (as is the case for the peak current and the plasma currents). This reduces the radiation. This offers the advantage that the power supplies have to decouple fewer high frequency components. For this reason and because of the reduction of the peak current, the power supplies may contain capacitors which have to conform to less stringent demands. This allows the use of cheaper capacitors or a reduction of the risk of failure due to malfunction of a capacitor, or a mix of both advantages. However, the embodiment with 2×2 groups has some distinct advantages in that it is relatively simple and of symmetric design. Use can be made in embodiments of two electronically identical driver and/or energy recovery systems which reduces the costs.

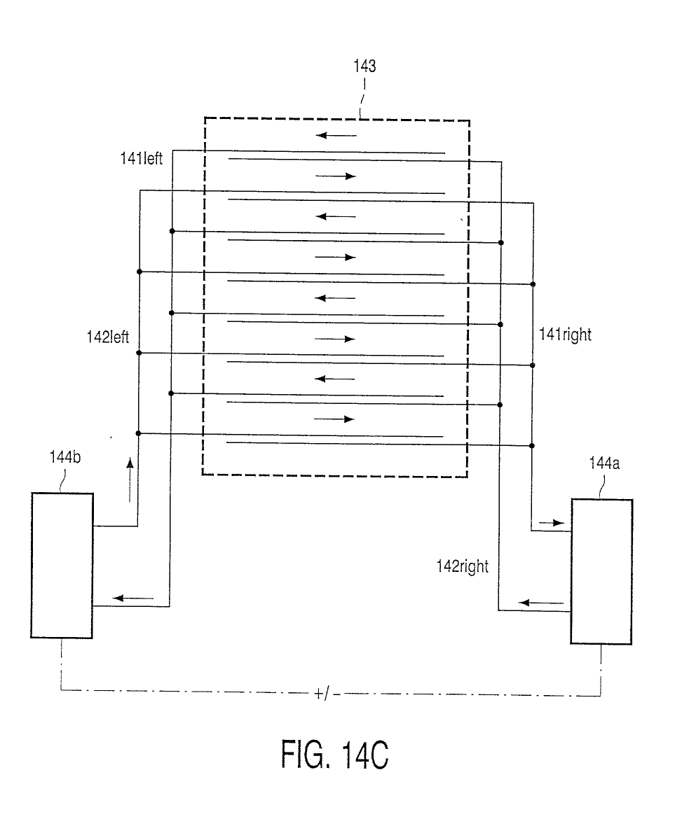

As explained above one possible embodiment is a display having several sections where the discharges take place at different times, for instance a 42″ display being divided into four equal sections, each having two interdigitated electrodes in which the sustain discharges take place at different times. FIGS. 14A and 14B show a very advantageous wiring arrangement for such a section 143. Each electrode 141, 142 of the panel section 143 comprises two sets of sub-electrodes 141a, 141b; 142a, 142b distributed at either side of the panel etc which are arranged in pairs (141a, 142a; 141b, 142b; 141c, 142c; etc) which are alternately arranged, i.e. the relative position of each sub-electrode vis-a-vis the other alternates between adjacent pairs. In the first pair (a) the top sub-electrode is part of 141, while the bottom sub-electrode is part of electrode 142, in the second pair (b) the opposite is the case (or in sequence going from top to bottom, the arrangement is {141, 142}; {142, 141}; {141, 142}; {142, 141}; {141, 142} etc). As a consequence, the currents during the first half of the sustain period (shown schematically in FIG. 14A) are opposite to each other in adjacent pairs. The same is true during the second half of the sustain period (FIG. 14B). By wiring the rows in an alternate way (i.e. the relative position of the electrodes alternating between adjacent rows) the plasma currents are in adjacent rows in opposite direction. The loop for the plasma current has been reduced to the distance between rows, which is much smaller than with a conventional display. This strongly reduces the radiation during the discharge.

In FIGS. 14A and 14B the sub-electrodes of electrodes 141 (Y1) and 142 (X1) at opposite sides of the panel are interconnected and a single driver circuit 144 is used to drive the electrodes. This requires interconnections 141 int and 142 int. Through these interconnections relatively large currents run. The interconnections can be eliminated by a scheme as schematically shown in FIG. 14C. Two driver circuits 144a and 144b are used, which are operated in opposite manner, i.e. the voltages and currents are substantially the same but of opposite sign. In FIG. 14C this is schematically indicated by the dotted lines and the +/− signs interconnecting the drivers 144a and 144b. The electrodes 141 and 142 are now subdivided in 141 left and 141 right, respectively 142 1eft and 142 right, in which arrangement 141 left and 141 right, respectively 142 1eft and 142 right are not physically connected by means of an interconnection 141 int respectively 142 int but form electrically a single electrode in operation due to the arrangement of the sub-electrodes and the opposite manner of driving. By driving the driver circuits in an opposite manner, at al times the currents through the panels and drivers are in opposite phase. Applying the panel section as shown in FIGS. 14A, 14B, 14C with an erase voltage will cause the currents in the odd rows (a, c, e, f, h etc) to flow from the one side to another side of the panel, while the currents in the even rows (b, d, e, g etc) flow from the other side to the one side, thus in the opposite direction. In FIG. 14C this is schematically indicated by the +/− sign and the dotted lines between drivers 144a and 144b. This will also strongly reduce electromagnetic radiation during the erase period.

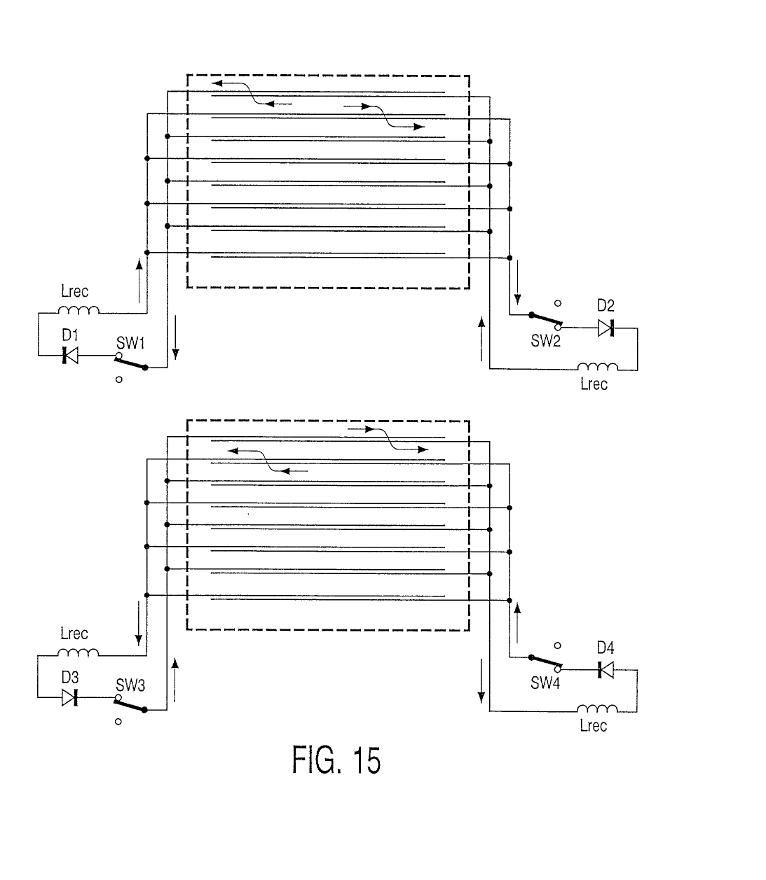

FIG. 15 shows how it is possible using the set-up of FIG. 14C to obtain a new energy recovery topology which does not require an interconnection between opposite sides of the display panel. During scan recovery the current is recovered via de switches SW1 and SW2, the diodes D1 and D2 and the Lrec (top half of FIG. 15). During common recovery the energy is recovered via switches SW3, SW4 diodes D3, D4 and Lrec. Through the odd rows the recovery energy flows from left to right or right to left, through the even rows the recovery current flows in the opposite direction. Since the recovery current flows back and forth through each section there is no need for a conductor at the back of the panel, which reduces the costs.

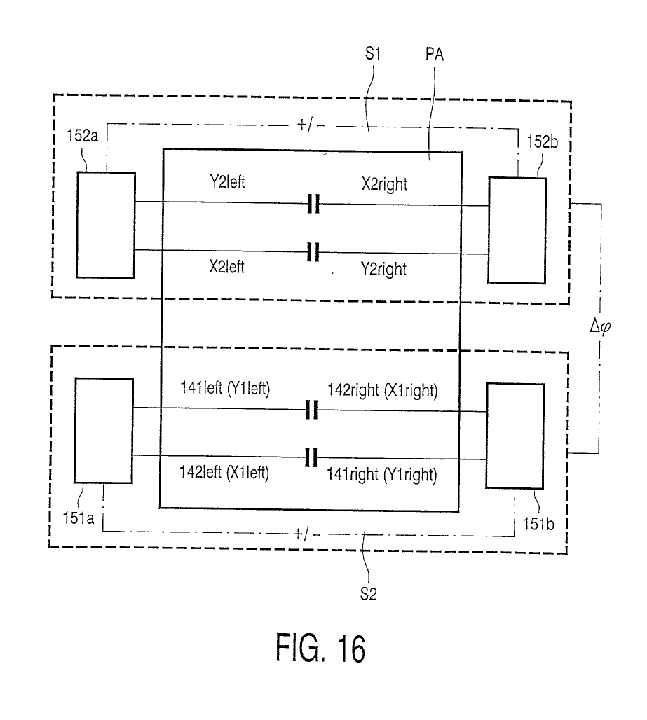

FIG. 16 illustrates an embodiment of the invention in which the panel is subdivided into two sections S1 and S2 each having a pair of electrodes X, Y. Schematically the coupling between the odds rows is indicated as is the coupling between the Y2 1eft and X2 right or Y1 left and X1 right. Two driver circuits 151, 152 are indicated. The fact that the drivers circuits 151a, 151b and 152a and 152b are driving in opposite is indicated by the +/− sign in each section. The fact that a time difference between the sustain discharge (and in fact between all voltages) in each section and thus between the groups Y1-X1 and Y2-X2 is implemented is schematically indicate by the Δφ sign and the dash-dotted lines interconnecting section S1 and S2. In this example the display panel comprises two sections. Preferably four sections are used, with a time difference equal to one fourth of the period. The example as shown in FIG. 16 (whether with 2 ro 4 sections is in particular advantageous since not only are peak currents reduced but also within each section sustain, recovery and address currents are both in the panel sections (the electrodes at the screen) as well as in the drivers opposite to each other, which reduces the loss and radiation. The same drivers can be usde which is a further advantage.

In summary the invention can be described as follows:

A display device comprises groups of scan electrodes (X1, X2) and groups of sustain electrodes (Y1-Y2) forming groups of electrode pairs (X1-Y1, X1-Y2, X2-Y1, X2-Y2). The sustain discharge for at least one of these groups occur at a different time than for at least one other group. The currents during sustain discharge are then distributed in time, reducing the peak heights and reducing losses.

It will be clear many variations are possible that within the scope of the invention.

1. A flat panel display apparatus comprising plasma discharge cells (C) having sustain electrodes (Su) and scan electrodes (Sc), and a drive circuit, characterized in that the sustain electrodes comprise m groups of sustain electrodes (X1, X2) and the scan electrodes comprise n groups of scan electrodes (Y1, Y2) forming groups of electrode pairs (X1-Y1, X1-Y2, X2-Y1, X2-Y2), while, in operation, the drive circuit (2, 6) applies sustain pulses to the respective groups of electrode pairs which are shifted in phase such that plasma discharges (*) for at least one group of pairs (Y1-X1, Y2-X2) take place at a different time than for at least one other group (Y1-X2, Y2-X1) of the groups of pairs.

2. A flat panel display apparatus as claimed in claim 1, characterized in that m groups of sustain electrodes and n groups of scan electrodes form n*m groups of electrodes.

3. A flat panel display apparatus as claimed in claim 1, characterized in that each group of electrode pairs comprises a substantially equal number of electrode pairs.

4. A flat panel display apparatus as claimed in claim 1, characterized in that n and m≧2, while in operation, the drive circuit applies sustain pulses to the respective groups of sustain electrodes and groups of scan electrodes which are shifted in phase with respect to each other.

5. A display device as claimed in claim 1, characterized in that the phase shifts between pulses on the groups of scan electrodes are substantially an equal amount of 2π/m and/or the phase shifts between pulses on the groups of sustain electrodes are substantially an equal amount of 2π/n.

6. A display device as claimed in claim 5, characterized in that the number of groups of scan and sustain electrodes is the same (n=m), with n preferably being 2 and the phase difference between the sustain pulses applied to the groups of scan and sustain electrode pairs being substantially 2π/2n.

7. A display device as claimed in claim 6, characterized in that the device comprises two groups of sustain electrodes, and two groups of scan electrodes (m=n=2), the sustain pulses on the groups of scan electrodes being applied, in operation, substantially in counterphase with each other, the sustain pulses on the groups of sustain electrodes being applied, in operation, substantially in counterphase, and the phase difference between sustain pulses between the groups of sustain and scan electrodes being in operation substantially π/2 or a multiple thereof.

8. A display device as claimed in claim 1, characterized in that the display device comprises an energy recovery circuit (121, 122) and, during the energy recovery period, the scan and sustain electrodes are connected in a Wheatstone bridge configuration having a first (123), a second (124), a third (125) and a fourth (126) terminal, the first terminal being connected to a group of sustain electrodes (X1), the second to a group of scan electrodes (Y1), the third to a further group of sustain electrodes (X2) and the fourth to a further group of scan electrodes (Y1), with a first energy recovery circuit (121) being arranged between the first (123) and third (125) terminals and a second energy recovery circuit (122) being arranged between the second (124) and fourth (126) terminals.

9. A device as claimed in claim 1, characterized in that the device comprises an equal number of groups of scan and sustain electrodes (i.e. n=m) while, for each group of sustain electrodes, pairs are formed only with the scan electrodes of one group of scan electrodes forming n groups of electrode pairs (X1-Y1, X2, Y2) the groups being formed on separate sections (S1, S2) of the display, the sustain pulses in each section being shifted in phase (Δφ).

10. A device as claimed in claim 9 characterized in that for each section two driver circuits at opposite sides of the display screen are arranged (144a, 144b) and for the group (X1-Y1, X2, Y2) the electrodes are arranged in rows and in operation are driven such that for adjacent rows the sustain currents are opposite.

11. A device as claimed in claim 10, characterized in that for each section Two energy recovery systems are arranged at opposite sides of the display screen such that in operation recovery currents are for adjacent rows opposite.

12. A method of driving a flat panel display apparatus comprising plasma discharge cells (C) having sustain electrodes (Su) and scan electrodes (Sc), the device comprising groups of scan and sustain electrode pairs (X1-Y1, X1-Y2, X2-Y1, X2-Y2), characterized in that sustain pulses are applied to the respective groups of electrode pairs, the sustain pulses being shifted in phase such that plasma discharges (*) for at least one group of pairs (Y1-X1, Y2-X2) take place at a different time than for at least one other group (Y1-X2, Y2-X1) of the groups of pairs.
